(19) United States
(12) Patent Application Publication
(10) Pub. No.: US 2007/0018988 A1
(43) Pub. Date: Jan. 25, 2007

(54) Method and applications for rasterization of non-simple polygons and curved boundary representations

(76) Inventor: Michael Guthe, Koenigswinter (DE)

Correspondence Address: KOHLER SCHMID MOEBUS, RUPPMANNSTRASSE 27, D-70565 STUTTGART, DE

(21) Appl. No.: 11/485,264

(22) Filed: Jul. 13, 2006

Related U.S. Application Data
(60) Provisional application No. 60/700,725, filed on Jul. 20, 2005.

(51) Int. Cl. G06T 11/20

(52) U.S. Cl. 345/441

(57) ABSTRACT

A hardware-accelerated method for the rasterization of non-simple polygons is used to generate a trim-texture that is dynamically adapted to the required resolution. This method is combined with a GPU-based tessellation of parametric surfaces and a method to generate non-simple polygons with the required resolution from the parametric trimming curves on the GPU. This way trimming and tessellation of parametric surfaces like rational Bézier and Spline surfaces can be performed on the GPU. The method can also be used for the visualization of 2D boundary data on arbitrary parametric surfaces.

This application claims benefit of Ser. No. 60/700,725 filed on Jul. 20, 2005 the entire disclosure of which is hereby incorporated by reference.

### FIELD OF THE INVENTION

This invention relates generally to the field of computer graphics and more particularly to the rasterization of polygons.

### BACKGROUND OF THE INVENTION

The standard surface representation used in industrial CAD systems are trimmed non-uniform rational B-Spline (NURBS) surfaces. The main advantage of this representation is the ability to compactly describe a surface of almost any shape. However, graphics hardware is designed for rendering of triangles and therefore, all existing methods tessellate the trimmed surfaces, i.e. approximate them by triangle meshes. The basic approach used by these polygonal tessellation methods is to first approximate the surface itself with a mesh. For this approximation, typically a regular quad grid or an octree is used. Then the trimming curves are approximated as well and the intersections between those and the surface approximation are calculated. Examples for this approach are [Herzen and Barr 1987; Rockwood et al. 1989; Forsey and Klassen 1990]. Since the transfer of the geometry to the graphics hardware has become the bottleneck, an adaptive tessellation unit based on this approach was proposed by Abi-Ezzi and Subramanian [1994]. The main problem of this method is the trimming of the triangulated surface with the trimming loops converted into poly-lines, since irregular data structures are required.

If the boundary representation of the trimming is converted into an area-representation, e.g. stored in a texture, the trimming process itself can be performed on a per-pixel basis, removing the need for irregular data structures. However, the boundary poly-lines can be nested as well as intersecting. The rasterization of these non-simple polygons could be performed using scanline or ray-based approaches. However, these algorithms are more complicated than triangle ratserization and not well suited for hardware implementation.

Therefore, current hardware is restricted to the rasterization of triangles only. One way to rasterize these polygons is their triangulation. This again requires irregular data structures and thus the benefits of the texture-based approach are nullified.

There is accordingly a need for a rasterization method for non-simple polygons that can efficiently be performed in hardware.

### SUMMARY

The key to any tessellation algorithm is an efficient solution for the trimming. However, existing trimming approaches cannot be implemented on the GPU or in hardware due to the required irregular mesh data structures.

This invention describes a novel texture based trimming approach that does not perform any explicit meshing and only requires regular data structures. Therefore, it can efficiently be mapped to hardware and realized on current GPUs. Based on this invention, GPU-based rendering of trimmed NURBS, T-Spline or other parameterized surfaces becomes possible. For trimmed NURBS this results in an up to a thousand times compared to CPU-based tessellation. Other applications for this invention are the visualization of vector data on surfaces and the voxelization of arbitrary polyhedrons.

### BRIEF DESCRIPTION OF THE DRAWING

FIG. 1 is the fragment coverage of a non-simple polygon containing a hole.

FIG. 2 illustrates the conversion of trimming curve loops into triangle fans.

FIG. 3 is a schematic illustration of the general workflow for trimming and tessellation of parametric surfaces.

FIG. 4 is an example for a hierarchical bi-cubic approximation of a parametric surface.

FIG. 5 is a schematic illustration of the perspective reparametrization to reduce aliasing.

### DESCRIPTION OF THE PREFERRED EMBODIMENT

1. Overview

The following detailed description starts with the explanation in section 2 of the rasterization technique proposed in this invention. Section 3 describes the application to tessellation and trimming of parametric or parameterized surfaces. Section 4 provides a description on the application to vector data visualization on surfaces.

2. Rasterization Technique

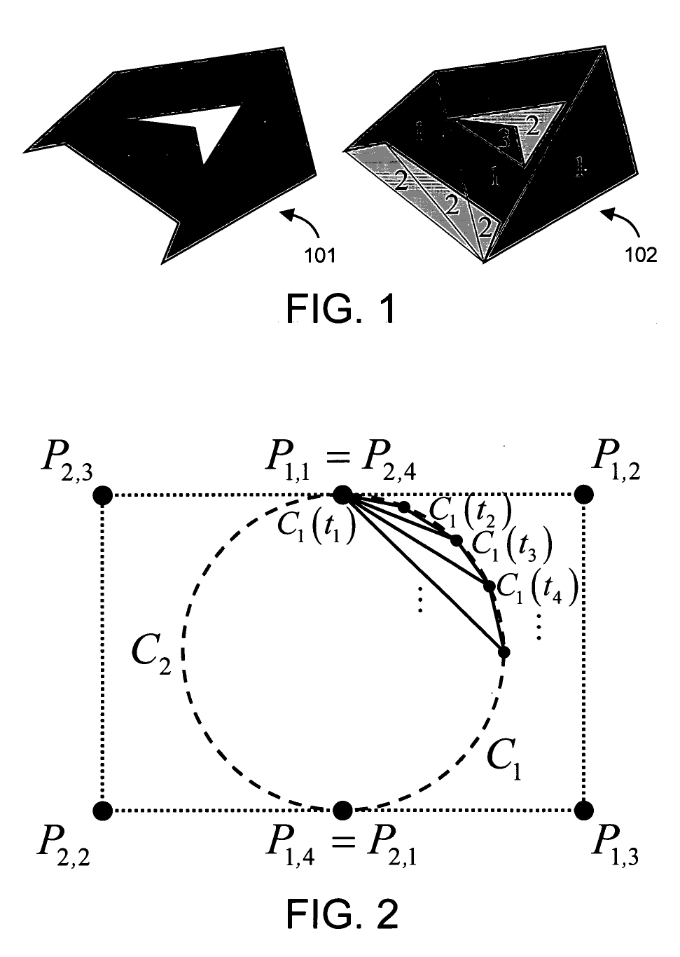

To rasterize an arbitrary polygon, as the example 101, which can contain holes and intersections, on triangle-based graphics hardware, a triangle fan is spanned for each loop of the polygon. The triangle fan is comprised of an ordered sequence of all vertices in the loop and can be in any orientation, where the first vertex is replicated at the end of the sequence. The center vertex of the triangle fan can be chosen arbitrarily and can also be a vertex of the loop. When these triangle fans are rasterized, a point inside the non-simple polygon will be covered an odd number of times by the triangles of the fan, while a point outside the polygon will be covered by an even number of times as shown in FIG. 1, 102. Instead of counting the coverages, only the lowest bit (odd/even) is considered and the fragments are toggled between transparent and opaque or two different colors. A major advantage of this approach is that taking care of the orientation and nesting of trimming loops is not necessary and thus error prone special case handling is avoided.

The toggling between transparent and opaque can be performed by using hardware-supported blending functions. Possible configurations for these blending functions are for example 1−color_{destination} or 1−alpha_{destination} for the source blending factor with (1,1,1,1) as primary color and zero as destination blending factor with a clear color of (0,0,0,0).

3. Trimming and Tessellation of rational Bézier, Spline and Parameterized Surfaces

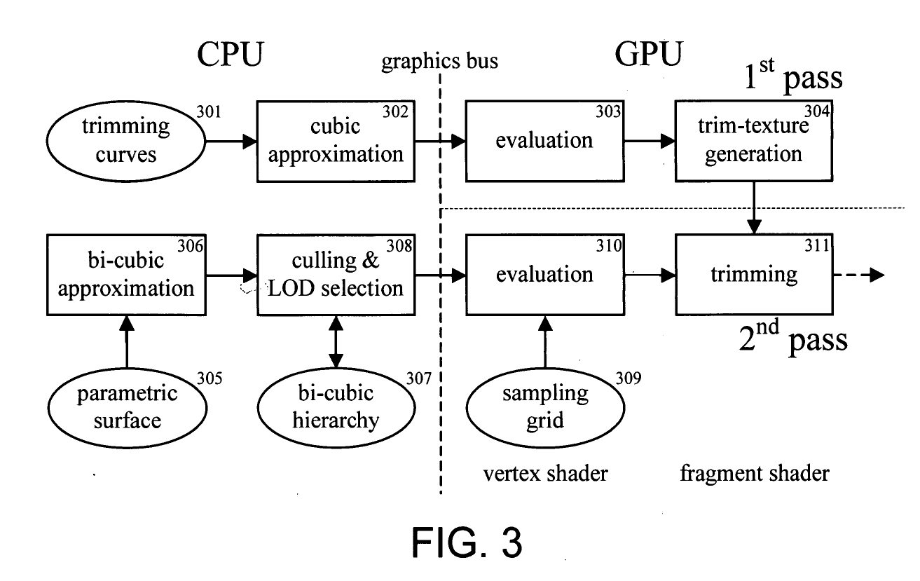

Since not all graphics cards support shaders of arbitrary length and number of variables, an approximation of each surface with a rational bi-cubic Bézier patch hierarchy can be performed. In this case the overall workflow is as shown in FIG. 3. In this case, the trimming curves 301 are first approximated by piecewise rational cubic Bézier curves 302. The method described in section 2 is modified to generate a texture for trimming in a single rendering pass on graphics hardware. Again, for each trimming loop a triangle fan is generated, as shown in FIG. 2. Instead of approximating the trimming curves on the CPU, the vertices Cₖ(tᵢ) at the parameter values tᵢ of this triangle fan are calculated in a vertex shader 303 using the control points of the corresponding curve segment Cₖ. This is done by initializing the vertex attributes with the control points Pⱼ and then sending the sampling parameter values t₁, . . . , tₙ as 1 d vertices. These values are used by a vertex program, which takes the control points as constants and evaluates the corresponding curve at the parameter values tᵢ. This way the vertices of the triangle fan are generated curve by-curve and the resulting triangles are rasterized. The toggling of the pixels is performed in the blending stage of the rendering pipeline. It is important to note, that this way the entire trim-texture generation is performed in a single rendering pass. The number of sampling values for each curve is calculated on the CPU in 302. According to the work of D. Filip, R. Magedson, and R. Markot, “Surface algorithms using bounds on derivatives”, Computer Aided Geometric Design vol. 3, no. 4, 1986, pp. 295-311, the number of required samples n for a piecewise linear approximation of a function f(t) over the interval [a,b] (which is always [0,1] for Bézier curves) with a maximum deviation of ε can be calculated by:

$$n = ⌈ ( b - a ) \sqrt{\frac{{sup}_{a \leq t \leq b} ‖ {f}^{′′} ( t ) ‖}{8 ɛ}} ⌉$$

A rational Bézier curve projected to the hyper plane w=1 can be written as:

$$C ( t ) = \frac{{\sum }_{i = 0}^{n} {P}_{i} {B}_{i}^{n} ( t )}{{\sum }_{i = 0}^{n} {P}_{i} {B}_{i}^{n} ( t )} = \frac{P ( t )}{w ( t )} ,$$

and its second derivative can be written as a rational Bézier curve with a degree 3n−2) nominator

$$\hat{P} ( t ) = {\sum }_{i = 0}^{3 n - 2} {\hat{P}}_{i} {B}_{i}^{3 n - 2} ( t )$$

and a degree 3 n denominator

$$\hat{w} ( t ) = {\sum }_{i = 0}^{3 n} {\hat{w}}_{i} {B}_{i}^{3 n} ( t ) .$$

Since all wᵢ
are positive by construction, all ŵᵢ are also positive. Therefore, an upper bound of the second derivative is given by:

$${sup}_{0 \leq t \leq 1} ‖ {C}^{′′} ( t ) ‖ \leq \frac{{max}_{i = 0}^{3 n - 2} {\hat{P}}_{i}}{{min}_{i = 0}^{3 n} {\hat{w}}_{i}}$$

Since the trimming curves are rasterized into a texture of a fixed resolution n×n and the approximation error should be less than half a pixel in the texture, ε is 1/2n.

Optionally, a parametric surface 305 is approximated with rational bi-cubic Bézier patches 306 to form a bi-cubic patch hierarchy 307. First, the surface is convert the surface into its piecewise rational Bézier representation. For the example of NURBS surfaces, the Oslo algorithm described by E. Cohen, T. Lyche, and R. F. Riesenfeld in “Discrete b-spline and subdivision techniques in computer aided geometric design and computer graphics”, Computer Graphics and Image Processing vol. 14, no. 2, 1980, pp. 87-111, is used. Afterwards each of these initial Bézier patches, which can be of arbitrary degree, is approximated with a bi-cubic patch. Since the error of this approximation may exceed a desired error bound, a binary hierarchy of bi-cubic patches (401,402,403) is build during rendering, while also a view frustum culling is performed (308), by recursive subdivision of the initial Bézier patches (404,405,406). To reduce the number of rendered bi-cubic patches these separate hierarchies are also combined into a single binary tree 407 using the median cut algorithm described by P. Heckbert in “Color image quantization for frame buffer display”, Computer Graphics (Proceedings of ACM SIGGRAPH 82) vol. 16, no. 3, 1982, pp. 297-307. After the tree is built, the bi-cubic patches are hierarchically simplified—each the two child patches approximated with a single bi-cubic patch—starting from the level of the initial Bézier patches. This simplification process is performed once when the surface is rendered for the first time. If this approximation is not performed, the surface is directly used for tessellation instead of the rational bi-cubic Bézier patches.

To find a good bi-cubic approximation of a single rational Bézier patch contained in a leaf node a constrained degree reduction is used. The approximation algorithm is derived completely from a generalized degree reduction. Therefore, it can simply be applied to rational curves by using the homogeneous representation-of the control points Pᵢ=[wᵢxᵢ wᵢyᵢ wᵢzᵢ wᵢ]^{T}. As Bézier surfaces are tensor product surfaces, degree reduction of the surface in one direction is equal to degree reduction of all curves in this direction. Previous degree reduction algorithms like A. Forrest, “Interactive interpolation and approximation by Bézier polynomials”, The Computer Journal vol. 15, no. 1, 1972, pp. 71-79, are equivalent to Hermite interpolation in the cubic case and thus preserve C¹ continuity. However, in the context of rendering, preserving G¹-continuity would be sufficient since only the direction of the tangent vector needs to be preserved. This leads to the following definition of the new control points:
\tilde{P}₀=P₀
\tilde{P}₁=P₀+λ₀(P₁−P₀)
\tilde{P}₂=Pₘ+λ₁(Pₙ₋₁−Pₙ)
\tilde{P}₃=Pₙ

The two free parameters λ₀ and λ₁ can now be used to minimize the total approximation error. The distance between two Bézier curves C₁(t) and C₂(t) of the same degree is bound by the maximum distance between their corresponding control points. Therefore, the degree of the approximating curve \tilde{C}(t) is elevated to that of the original curve C(t) to construct C̅(t) and then the control point distances are minimized:

$${\sum }_{i = 0}^{n} {‖ {P}_{i} - {\overline{P}}_{i} ‖}^{2} \to min$$

For this minimization problem the analytical solution is:

$${λ}_{0} = \frac{( {\sum }_{i = 0}^{4 n} {a}_{i} {b}_{i} ) ( {\sum }_{i = 0}^{4 n} {c}_{i}^{2} ) - ( {\sum }_{i = 0}^{4 n} {a}_{i} {c}_{i} ) ( {\sum }_{i = 0}^{4 n} {b}_{i} {c}_{i} )}{( {\sum }_{i = 0}^{4 n} {b}_{i}^{2} ) ( {\sum }_{i = 0}^{4 n} {c}_{i}^{2} ) - {( {\sum }_{i = 0}^{4 n} {b}_{i} {c}_{i} )}^{2}}$$

$${λ}_{1} = \frac{( {\sum }_{i = 0}^{4 n} {a}_{i} {c}_{i} ) ( {\sum }_{i = 0}^{4 n} {b}_{i}^{2} ) - ( {\sum }_{i = 0}^{4 n} {a}_{i} {b}_{i} ) ( {\sum }_{i = 0}^{4 n} {b}_{i} {c}_{i} )}{( {\sum }_{i = 0}^{4 n} {b}_{i}^{2} ) ( {\sum }_{i = 0}^{4 n} {c}_{i}^{2} ) - {( {\sum }_{i = 0}^{4 n} {b}_{i} {c}_{i} )}^{2}}$$

with
\vec{a}ᵢ=Pᵢ−P₀(γ_{i.0}+γ_{i.1})−Pₙ(γ_{i.2}+γ_{i.3})
\vec{b}ᵢ=(P₀−P₁)γ_{i.1}
\vec{c}ᵢ=(Pₙ−Pₙ₋₁)γ_{i.2},
where γᵢⱼ is the contribution of the simplified control point \tilde{P}ⱼ to the control point P̅ᵢ after degree elevation (i.e. they represent the degree elevation matrix). As the direction of the tangent vector flips when λ₀ or λ₁ becomes negative, a minimum value is used for each of them. In addition, when w₁<w₀ or wₙ₋₁<wₙ, a maximum value for λ₀ and λ₁ is given by

$$\frac{{w}_{0}}{{w}_{0} - {w}_{1}} and \frac{{w}_{n}}{{w}_{n} - {w}_{n - 1}}$$

respectively, as only positive weights \tilde{w}₁ and \tilde{w}₂ should be produced. After constructing the degree reduced curve an upper bound for the introduced error needs to be calculated. For this purpose the non-homogeneous representation of the control points Pᵢ and P̅ᵢ are used, as the error after projection to the hyperplane w=1 is required. The approximation error ε_{c} is then:

$${ɛ}_{c} \leq {max}_{i = 0}^{n} ‖ {[ \begin{matrix}{x}_{i} & {y}_{i} & {z}_{i}\end{matrix} ]}^{T} - {[ \begin{matrix}{\overline{x}}_{i} & {\overline{y}}_{i} & {\overline{z}}_{i}\end{matrix} ]}^{T} ‖$$

As the approximation error ε is not known in advance, additional subdivisions are performed to extend the hierarchy until the approximation error is low enough for the current screen space error.

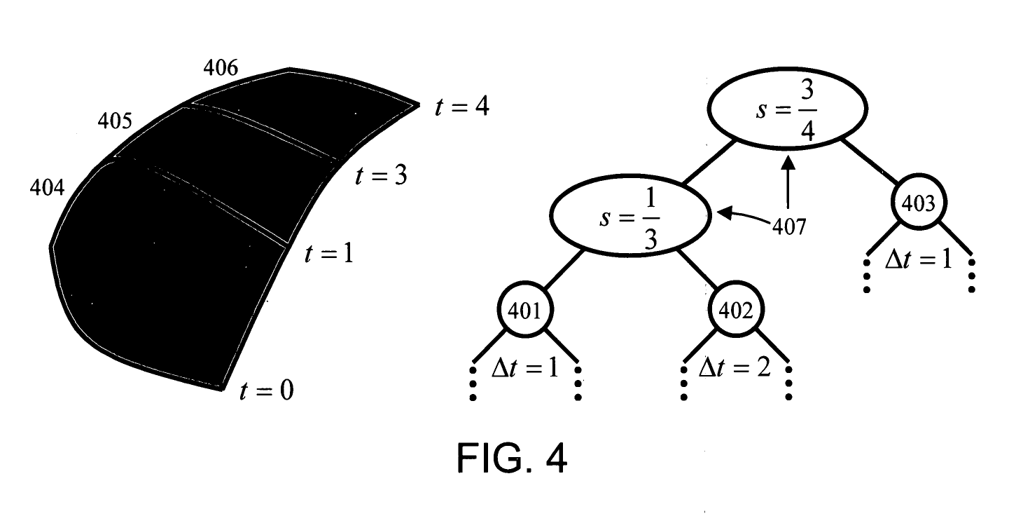

To fill the upper part of the bi-cubic Bézier hierarchy described above pair wise approximation of two bi-cubic Bézier patches by a single bi-cubic patch is performed. Similarly to the approximation of a single Bézier patch this simplification is derived from subdivision and thus rational patches are accounted for by using the homogeneous control points. Since the simplification of two Bézier patches into a single one can be viewed as the inverse of subdivision, λ₀ and λ₁ are calculated by considering a subdivision of the simplified patch at the parameter value s. As this subdivision has to preserve the knot intervals of the two child patches the parameter s is given by

$$s = \frac{Δ {t}_{1}}{Δ {t}_{1} + Δ {t}_{2}} ,$$

where Δt₁ and Δt₂ are the lengths of the knot intervals of the two child patches in the partition direction (see FIG. 4). Now the same minimization problem as for the approximation of a single rational Bézier patch is set up. The γᵢⱼ are then defined by the subdivision matrix of s instead of the degree elevation matrix. Finally, an upper bound of the error introduced by simplification is calculated by subdividing the simplified patch at s and then exploiting the convex hull property of the difference curves.

The selection of sufficiently accurate rational bi-cubic Bézier patches (308) is done on the CPU by traversing the bi-cubic patch hierarchy associated with the surface starting at the root node. When a patch with sufficient accuracy is found, it is selected for rendering and the rest of the subtree is skipped. During the traversal hierarchical view-frustum culling based on the bounding box of the current Bézier patch is also performed. If the patch is visible, the required object space error ε to guarantee a screen space error of ε_{img} is calculated using the distance of the viewer to this bounding box. This object space error is then split equally between the bi-cubic approximation error and the sampling error.

For each patch that is selected for rendering the tessellation is performed using a sampling grid 309 stored as triangle mesh in a vertex array on the graphics card. According to the work of D. Filip, R. Magedson, and R. Markot, “Surface algorithms using bounds on derivatives”, Computer Aided Geometric Design vol. 3, no. 4, 1986, pp. 295-311, the error when approximating a C²-continuous surface with two triangles spanning the bilinear parameter space rectangle D=[(u₀,v₀), (u₁,v₁)] is bounded by

$${sup}_{p ∈ D} ( δ ) \leq \frac{1}{8} ( Δ {u}^{2} {M}_{u} + 2 Δ u Δ {vM}_{uv} + Δ {v}^{2} {M}_{v} ) , \\ with {M}_{u} = {sup}_{p ∈ D} ‖ \frac{{\partial }^{2} S}{\partial {u}^{2}} ‖ , {M}_{v} = {sup}_{p ∈ D} ‖ \frac{{\partial }^{2} S}{\partial {v}^{2}} ‖ , \\ and {M}_{uv} = {sup}_{p ∈ D} ‖ \frac{{\partial }^{2} S}{\partial u \partial v} ‖ .$$

Now the sampling densities in u- and v-direction are separated by exploiting the fact that ab≦½(a²+b²) and thus the approximation error is bound by

$${sup}_{p ∈ D} ( δ ) \leq \frac{1}{8} ( Δ {u}^{2} ( {M}_{u} + {M}_{uv} ) + Δ {v}^{2} ( {M}_{v} + {M}_{uv} ) ) ,$$

which is a simple addition the two approximation errors in u- and v-directions. Thus ε is an upper bound for the approximation error if the error in both directions is not greater than ε/2.

When a patch has no trimming and the parameter value is not used for texturing, it is not necessary to preserve its parameterization. In this case an upper bound for the distance of a curve to an evenly parameterized line segment is not required. Instead, any re-parameterization of this degree elevated line segment can be used. This means that the middle control points can freely move between the two end points of the line segment. Therefore, the closest point on the line segment is calculated for each control point of the curve. These points then define a re-parameterized line segment and the difference vectors to the control points define the difference curve. Using the maximum second derivative of this difference curve the required sampling resolution for a purely geometric approximation can be calculated which is lower that in the parametric case.

For trimmed surfaces the required trim-texture resolution has to be calculated additionally to the grid resolution. To guarantee a desired error of ε along the trimming curves, both the surface and the trimming curves need to be approximated with an accuracy of ε/2. Therefore, the distance between two neighboring pixels of the texture has to be at most ε on the evaluated surface. Thus the texture resolution can be calculated from the maximum absolute value of the first surface derivatives:

$${res}_{u} ⌈ \frac{{u}_{1} - {u}_{0}}{ɛ} {sup}_{p ∈ [ ( 0 , 0 ) , ( 1 , 1 ) ]} ‖ \frac{\partial S ( p )}{\partial u} ‖ ⌉$$

and analogously for the v-resolution, where [(u₀,v₀), (u₁,v₁)] is the domain interval of the current bi-cubic Bézier patch. Again, the maximum surface derivative in u- or v-direction is bound by the maximum derivative of the corresponding iso-parameter curves, which can be written in rational Bézier form with degree (2n−1) nominator and degree 2n denominator. An upper bound for the absolute value is:

$${sup}_{0 \leq t \leq 1} ‖ {C}^{′} ( t ) ‖ \leq \frac{{max}_{i = 0}^{2 n - 1} {\hat{P}}_{i}}{{min}_{i = 0}^{2 n} {\hat{w}}_{i}} .$$

A problem occurs, when the viewer moves very close to a surface. In this case the patch size becomes much larger than the screen and therefore, the required trim-texture resolution would exceed the maximum possible texture resolution by orders of magnitude. To overcome this limitation, the surface is subdivided on the CPU until the trim-texture of each patch is small enough. If a hierarchy of bi-cubic patches is used, it is only necessary to modify the bi-cubic approximation error. In addition, only a trim-texture for the domain region covered by visible patches needs to be generated.

After the trim-texture is constructed, it is bound and the trimming is performed in the fragment shader 311 after the tessellation. When the patch is rendered, simply all fragments are killed for which the intensity of the trim-texture is lower than a threshold value. If fragment shaders are not supported, the trim-texture is used as alpha texture with an alpha test to discard trimmed fragments.

In order to reduce the number of render target switches, a trim-texture atlas is generated for multiple patches, which contains all trim-textures of these patches. When several trimmed patches are rendered at once, first the required sizes of all stencil textures of the corresponding patches are calculated and sorted by their height. Then the rectangular trim-textures are placed beside each other at the bottom line of the atlas. When the next texture would exceed the maximum texture width, a new row is started. After the texture atlas is filled (i.e. adding the next trim-texture would exceed the maximum texture height) or all trim-textures have been added, the trim-textures are rendered into the atlas. For each patch only the view port needs to be set according to the position and resolution of its trim-texture. When all trim-textures are generated, the algorithm switches back to the screen buffer and renders all patches for which the trimming is contained in the current texture atlas. Untrimmed patches can immediately be rendered before generating the first trimming atlas. If the texture atlas was filled before all trim-textures could be added, the algorithm continues with the next texture atlas.

Additionally, the bounding box of the trimming region is calculated and knot insertion is applied at the minimum and maximum u and v parameter values. Then, all Bézier patches outside this region are removed. If the trimming is only used to cut out a rectangular region of the surface domain, no trimming is necessary at all after removing the unused domain regions. This is the case, if only a single loop exists and each trimming curve lies completely on one side of the domain boundary. Then the patch can be rendered without a trim-texture. When selecting the bi-cubic patches for rendering neighboring patches are subdivided independently, which can introduce cracks between bi-cubic patches. Trimmed parametric surfaces are also tessellated individually, which may introduce cracks between neighboring surfaces as well. Both types of cracks need to be closed. To achieve this, a technique build upon the fat border algorithm described in Á. Balázs, M. Guthe, and R. Klein, “Fat borders: Gap filling for efficient view-dependent lod rendering” Computers & Graphics vol. 28, no. 1, 2004, pp. 79-86, which conceals the cracks by rendering appropriately shaded triangle strips behind each trimming loop. Since the vertex shader would need more than the 12 temporary registers available in the vertex shader 1.0 extension to calculate the position, normal and tangent vectors for a point on the trimming curve, this approach cannot be used directly. To fill the cracks between the bi-cubic patches, a simple line strip is rendered around each sampling grid resulting in only a slightly lower quality than the original fat borders approach. For a screen space error of ε_{img} the width of this line strip is 2ε_{img}, e.g. one pixel for a screen space error of half a pixel. For untrimmed surfaces the cracks along their boundary do not need to be filled explicitly, since they are already filled by the Bézier patch crack-filling algorithm. Therefore, only the cracks along trimming curves need to be filled. After generating the trim-texture with the algorithm described above, an additional line strip is rendered along each trimming loop. The width of this line strip is always one pixel since the accuracy of the trimming curves in texture space is 0.5 pixels.

For the trimming of parameterized surfaces, only the steps 304 and 311 (and possibly the steps 302 and 303 if the boundary is defined by parametric curves) are required.

4. Vector Data Visualization on Surfaces

Using the technique described in section 2, the entire alpha texture for a GIS layer, which is defined as a set of non-simple polygons, can be generated in a single rendering pass. If only a single layer is rendered, the alpha texture can be directly used in a fragment shader. The color of the layer can be defined by setting an appropriate vertex attribute that is then multiplied in the shader before blending. When multiple layers are activated for rendering, they are first combined into a single texture. This is performed by accumulating the layers in a second off screen buffer of the same size using standard alpha blending. No specialized shader is required for accumulation, since the primary color can be used to specify the color of the current layer. This way, an arbitrary number of possibly semitransparent layers can be rendered on the terrain with only two additional textures. Since the required texture size would become huge, if uniform texture coordinates were used, a re-parameterization is required.

Due to limited memory, the resolution of the vector data texture can only be increased up to a certain limit in practice. In shadow mapping, perspective aliasing is significantly reduced by re-parameterizing the shadow map. In order to improve the visual quality of the mapping of the vector data, a perspective re-parameterization of the on the fly created texture is used depending on the current view by adapting the technique used in perspective shadow mapping.

In shadow mapping (L. Williams, “Casting Curved Shadows on Curved Surfaces”, Computer Graphics vol. 12, 1978), the scene is first rendered from the view of the light, storing the depth values in separate buffer. When the scene is then rendered from the normal viewing position, each pixel is transformed again into the light view and its depth value is compared to those stored in the shadow map. Perspective shadow maps (M. Stamminger and G. Drettakis, “Perspective Shadow Maps” SIGGRAPH 2002) attempt to reduce perspective aliasing and thus improve shadow quality by performing a perspective re-parameterization. Further improvements of perspective shadow mapping were presented in M. Wimmer, D. Scherzer, and W. Purgathofer, “Light Space Perspective Shadow Maps”, Eurographics Symposium on Rendering, 2004, which is adopted for this technique.

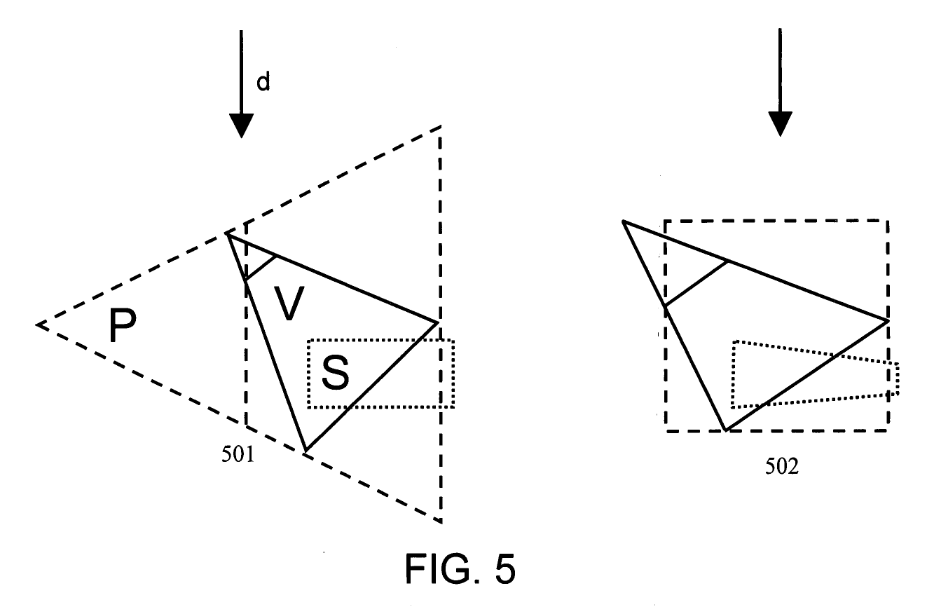

The rendering process is then performed as follows. The current view frustum V is enclosed with an appropriate frustum P that has a view vector perpendicular to the projection direction of the vector data (FIG. 5). By varying the length of this frustum the strength of the warping effect can be controlled. The perspective transformation induced by this frustum P is applied in two places, namely during the generation of the vector data texture and in the texture coordinate generation during rendering.

In contrast to perspective shadow mapping there is no lighting but a projection direction in which the vector data is mapped onto the terrain. Instead of rendering the whole scene from this direction and storing depth values as in shadow mapping, the vector data is simply rendered into the offsreen buffer. During rendering of the terrain, the offsreen buffer is bound or copied to a texture and appropriate texture coordinates are generated according to the perspective projection of P. These texture coordinates are then used to access the previously created texture.

It is to be understood that mechanisms and techniques that have been described above are merely illustrative of certain preferred embodiments. Numerous modifications may be made to the methods described without departing from the true spirit and scope of the invention.

### REFERENCES

S. S. Abi-Ezzi and S. Subramanian, “Fast dynamic tessellation of trimmed nurbs surfaces”, Computer Graphics Forum vol. 13, no. 3, 1994, pp. 107-126.
Á. Balázs, M. Guthe, and R. Klein, “Fat borders: Gap filling for efficient view-dependent lod rendering” Computers & Graphics vol. 28, no. 1, 2004, pp. 79-86.
J. Bolz, and P. Schröder, “Evaluation of subdivision surfaces on programmable graphics hardware”, 2003.
M. Bóo, M. Amor, M. Doggett, J. Hirche, and W. Stral3er, “Hardware support for adaptive subdivision surface rendering”, Workshop on Graphics Hardware, 2001, pp. 33-40.
J. Chhugani, and S. Kumar, “View-dependent adaptive tessellation of spline surfaces”, Symposium on Interactive 3D Graphics, 2001, pp. 59-62.
E. Cohen, T. Lyche, and R. F. Riesenfeld in “Discrete b-spline and subdivision techniques in computer aided geometric design and computer graphics”, Computer Graphics and Image Processing vol. 14, no. 2, 1980, pp. 87-111.
M. Eck, “Degree reduction of bézier curves”, Computer Aided Geometric Design vol. 10, no. 3-4, 1993, pp. 237-252.
D. Filip, R. Magedson, and R. Markot, “Surface algorithms using bounds on derivatives”, Computer Aided Geometric Design vol. 3, no. 4, 1986, pp. 295-311.
A. Forrest, “Interactive interpolation and approximation by bézier polynomials”, The Computer Journal vol. 15, no. 1, 1972, pp. 71-79.
D. R. Forsey, and R. V. Klassen, “An adaptive subdivision algorithm for crack prevention in the display of parametric surfaces”, Graphics Interface, 1990, pp. 1-8.
P. Heckbert in “Color image quantization for frame buffer display”, Computer Graphics (Proceedings of ACM SIGGRAPH 82) vol. 16, no. 3, 1982, pp. 297-307.
B. V. Herzen, and A. H. Barr, “Accurate triangulations of deformed, intersecting surfaces”, Computer Graphics vol. 21, no. 4, 1987, pp. 103-110.
T. Kanai, and Y. Yasui, “Per-pixel evaluation of parametric surfaces on gpu”, ACM Workshop on General Purpose Computing Using Graphics Processors, 2004.
S. Kumar, D. Manocha, H. Zhang, and K. E. Hoff “Accelerated walkthrough of large spline models”, Symposium on Interactive 3D Graphics, 1997, pp. 91-102.
T. Nishita, T. W. Sederberg, and M. Kakimoto “Ray tracing trimmed rational surface patches”, Computer Graphics vol. 24, no. 4, 1997, pp. 337-345.
Y. Park and U. J. Choi, “Degree reduction of bézier curves and its error analysis” J. Austral. Math. Soc. Ser. B vol. 36, 1995, pp. 399-413.
A. P. Rockwood, K. Heaton, and T. Davis, “Real-time rendering of trimmed surfaces”, Computer Graphics vol. 23, no. 3, 1989, pp. 107-116.
M. Shantz and S.-L. Chang, “Rendering trimmed NURBS with adaptive forward differencing”, Computer Graphics vol. 22, no. 4, 1988, pp. 189-198.
M. Stamminger and G. Drettakis, “Perspective Shadow Maps” SIGGRAPH 2002.
L. Williams, “Casting Curved Shadows on Curved Surfaces”, Computer Graphics vol. 12, 1978.
M. Wimmer, D. Scherzer, and W. Purgathofer, “Light Space Perspective Shadow Maps”, Eurographics Symposium on Rendering, 2004.
J. Zheng and G. Wang, “Perturbing bézier coefficients for best constrained degree reduction in the 1₂-norm”, Graphical Models vol. 65, 2003, pp. 351-368.

What is claimed is:

1. A method for the rasterization of non-simple polygons, the method comprising the steps of:
triangulating each loop into a triangle fan centered at an arbitrary vertex;
rasterizing each triangle fan using standard rasterization hardware; and
toggling fragments, using a blend function or equation, to be inside or outside a non-simple polygon, depending on whether a number of coverages by the triangle fan is odd or even.

2. A method for the tessellation and trimming of trimmed rational Bézier and Spline surfaces, the method comprising the steps of:
converting, if required, rational Spline surfaces into piecewise rational Bézier surfaces;
approximating, if required, arbitrary degree surfaces with bi-cubic surfaces;
approximating surface patches of arbitrary degree with pre-defined quad- or triangle-grids using a vertex program;
generating trimming textures with adapted resolution to control an error in screen space by conversion of trimming curves into nested non-simple polygons including rasterization thereof into a texture;
packing, if required, trim-textures into a texture atlas to reduce render target switches;
trimming surfaces using either an alpha test or a fragment shader to discard trimmed fragments; and
filling, if required, cracks by rendering line-strips around each tessellated patch and along each trimming loop;

3. A method for trimming of parameterized surfaces, the method comprising the steps of:
converting, if required, trimming boundaries into non-simple polygons;
generating trimming textures with adapted resolution to control an error in screen space by rasterization of non-simple polygons defining a trimming region texture;
trimming surfaces using either an alpha test or a fragment shader to discard trimmed fragments; and
closing, if required, cracks by rendering a line-strip along each trimming boundary.

4. A method for the visualization of vector data on surfaces, the method comprising the steps of:
rasterizing vector data into a texture;
combining, if required, several vector datasets into a single texture; and
projectively mapping generated texture onto the surface.
